(19) United States
(12) Patent Application Publication
(10) Pub. No.: US 2017/0293274 A1
(43) Pub. Date: Oct. 12, 2017

(54) APPARATUS FOR MANAGING DUAL LEVEL RESET OF MICROGRID GATEWAY FOR NEW REGENERATION ENERGY MANAGEMENT SYSTEM AND METHOD THEREOF

(71) Applicant: NexChal Co., Ltd., Seongnam-si (KR)

(72) Inventors: Gab Keun CHOI, Seoul (KR); Gi Ung SONG, Seoul (KR); Byeong Keun SONG, lncheon (KR); Yong Suk PARK, Suwon-si (KR); Ssang Suk OH, Seoul (KR); Hak JANG, Anyang-si (KR); Hee Jeong PARK, Daejeon (KR); Jun Sung KIM, Daejeon (KR)

(21) Appl. No.: 15/140,055

(22) Filed: Apr. 27, 2016

(30) Foreign Application Priority Data
Apr. 11, 2016 (KR) 10-2016-0044092

(51) Int. Cl. G05B 19/042

(52) U.S. Cl. CPC G05B 19/042; G05B 2219/2639

(57) ABSTRACT

Provided are an apparatus for managing a dual level reset of a microgrid gateway for a new generation energy management system and a method thereof. That is, according to the present invention, it is possible to help a stable operation until a person for maintenance arrives on the scene to take action even though a fail occurs in the system by determining whether the system normally operates and enhance stability of a gateway, by performing a reset function for the entire system when a software defect other than a hardware defect is verified.

### CROSS-REFERENCE TO RELATED APPLICATION

This application claims the benefit of Korean Application No. 10-2016-0044092, filed on Apr. 11, 2016 with the Korean Intellectual Property Office, the disclosure of which is incorporated herein by reference.

### BACKGROUND OF THE INVENTION

### 1. Field of the Invention

The present invention relates to an apparatus for managing a dual level reset of a microgrid gateway for a new generation energy management system and a method thereof, and particularly, to an apparatus for managing a dual level reset of a microgrid gateway for a new generation energy management system and a method thereof that performs a reset function for the entire system when a software defect other than a hardware defect is verified.

### 2. Description of the Belated Art

A fail safe design is a technique used in an industry field in which the fatal disaster happens when there are problems in equipment of rails, aircrafts, space crafts, nuclear power plants, and the like, and a technique which is necessarily provided in equipment of a power field as the national infrastructure.

Particularly, in a system of connecting existing power equipment based on a network through various sensors like supervisory control and data acquisition (SCADA), due to a feature of efficiently managing power by controlling the system by using various information input from the power system, a normal operation of a gateway that collects a sensing signal and links the collected sensing signal to a higher system such as an energy management system (EMS) is required as a much important function.

Furthermore, in microgrid fields for new generation energy, due to a feature of changing natural energy such as wind, solar, and tidal energy into power energy, an installation place of the equipment is most of places where an operating environment such as a temperature, humidity, dust, and the like is poor.

As such, even though an error occurs due to an operational environmental feature of the microgrid gateway, a design feature of the gateway that stably transmits sensing data acquired from the equipment to a control system is required, but the feature is not reflected well.

### PRIOR ART DOCUMENT

[Patent Document] (Patent Document 1) Korean Patent registration No. 10-1097458, titled “Micro-grid system and method for controlling load in a static transfer switch”

### SUMMARY OF THE INVENTION

An object of the present invention is to provide an apparatus for managing a dual level reset of a microgrid gateway for a new generation energy management system and a method thereof that performs a reset function for the entire system when a software defect other than a hardware defect is verified.

According to an aspect of the present invention, a method for managing a dual level reset of a microgrid gateway for a new generation energy management system includes: transmitting, by a main processing unit (MPU), a first trigger signal through a general purpose input output (GPIO) before executing any one of a plurality of functions; receiving, by a watchdog manager, the first trigger signal transmitted from the MPU; transmitting, by the MPU, a second trigger signal to the watchdog manager through the GPIO after any one function is executed; receiving, by the watchdog manager, the second trigger signal transmitted from the MPU; collecting, by the watchdog manager, an output pattern of a GPIO signal related with the function according to the first trigger signal and the second trigger signal; comparing, by the watchdog manager, an output pattern of a predetermined normal pattern related with the function with the collected output pattern of the GPIO signal; and resetting, by the watchdog manager, the entire system including the watchdog manager, when the output pattern of the predetermined normal pattern related with the function does not coincide with the collected output pattern of the GPIO signal as the compared result.

Preferably, in the comparing, whether the output pattern of the GPIO signal is present in a predetermined error range of the output pattern of the normal pattern may be compared.

Preferably, the method may further include collecting the output pattern of the GPIO signal for another function of the plurality of functions, when the output pattern of the predetermined normal pattern related with the function coincides with the collected output pattern of the GPIO signal, as the compared result.

According to another aspect of the present invention, an apparatus for managing a dual level reset of a microgrid gateway for a new generation energy management system includes: an MPU configured to transmit a first trigger signal through a GPIO before executing any one of a plurality of functions and transmit a second trigger signal through the GPIO after any one function is executed; and a watchdog manager configured to collect an output pattern of a GPIO signal related with the function according to the first trigger signal and the second trigger signal which are transmitted from the MPU, respectively, compare an output pattern of a predetermined normal pattern related with the function with the collected output pattern of the GPIO signal, and reset the entire system including the watchdog manager, when the output pattern of the predetermined normal pattern related with the function does not coincide with the collected output pattern of the GPIO signal as the compared result.

Preferably, the watchdog manager may compare whether the output pattern of the GPIO signal is present in a predetermined error range of the output pattern of the normal pattern.

Preferably, the watchdog manager may collect the output pattern of the GPIO signal for another function of the plurality of functions, when the output pattern of the predetermined normal pattern related with the function coincides with the collected output pattern of the GPIO signal as the compared result.

Preferably, the watchdog manager may be constituted in the MPU.

As described above, according to the present invention, it is possible to help a stable operation until a person for maintenance arrives on the scene to take action even though a fail occurs in the system by determining whether the system normally operates and enhance stability of a gateway, by performing a reset function for the entire system when a software defect other than a hardware defect is verified.

### BRIEF DESCRIPTION OF THE DRAWINGS

FIG. 1 is a block diagram illustrating a configuration of an apparatus for managing a dual level reset of a microgrid gateway for a new generation energy management system according to an exemplary embodiment of the present invention.

FIG. 2 is a diagram illustrating a configuration of an apparatus for managing a dual level reset of a microgrid gateway for a new generation energy management system constituted by a plurality of MPU according to another exemplary embodiment of the present invention.

FIG. 3 is a flowchart illustrating a method for managing a dual level reset of a microgrid gateway for a new generation energy management system according to yet another exemplary embodiment of the present invention.

FIG. 4 is a diagram illustrating an example of a pseudo code for a software watchdog according to the exemplary embodiment of the present invention.

FIG. 5 is a diagram illustrating an example of an output pattern of a GPIO signal for the watchdog according to the exemplary embodiment of the present invention.

### DETAILED DESCRIPTION OF THE EMBODIMENTS

It is noted that technical terms used in the present invention are used to just describe a specific embodiment and do not intend to limit the present invention. Further, if the technical terms used in the present invention are not particularly defined as other meanings in the present invention, the technical terms should be appreciated as meanings generally appreciated by those skilled in the art and should not be appreciated as excessively comprehensive meanings or excessively reduced meanings. Further, when the technical term used in the present invention is a wrong technical term that does not accurately express the spirit of the present invention, the technical term should be understood by being substituted by a technical term which can be correctly understood by those skilled in the art. In addition, a general term used in the present invention should be interpreted as defined in a dictionary or contextually, and should not be interpreted as an excessively reduced meaning.

In addition, singular expressions used in the present invention include plurals expressions unless they have definitely opposite meanings. In the present invention, it should be not analyzed that a term such as “comprising” or “including” particularly includes various components or various steps disclosed in the specification and some component or some steps among them may be not included or additional components or steps may be further included.

In addition, terms including ordinal numbers, such as ‘first’ and ‘second’, used in the present invention can be used to describe various components, but the components should not be limited by the terms. The above terms are used only to discriminate one component from the other components. For example, a first component may be named a second component and similarly, the second component may also be named the first component, without departing from the scope of the present invention.

Hereinafter, preferable exemplary embodiment of the present invention will be described in more detail with reference to the accompanying drawings. Like reference numerals refer to like elements for easy overall understanding and a duplicated description of like elements will be omitted.

Further, in the following description, a detailed explanation of known related technologies may be omitted to avoid unnecessarily obscuring the subject matter of the present invention. Further, it is noted that the accompanying drawings are only for easily understanding the spirit of the present invention and it should not be interpreted that the spirit of the present invention is limited by the accompanying drawings.

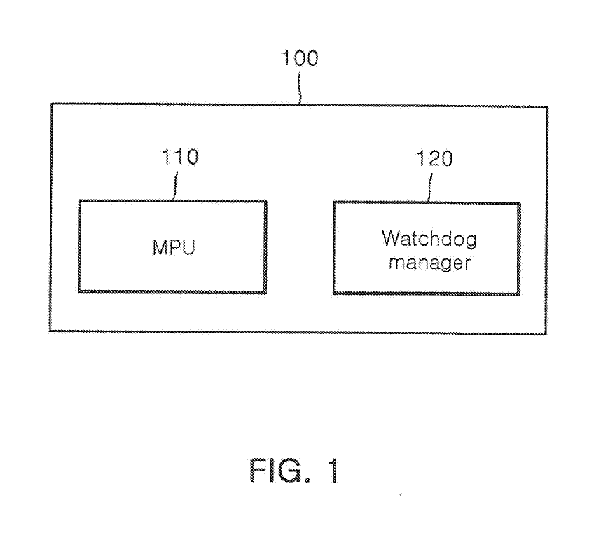

FIG. 1 is a block diagram illustrating a configuration of an apparatus 100 for managing a dual level reset of a microgrid gateway for a new generation energy management system according to an exemplary embodiment of the present invention.

As illustrated in FIG. 1, the apparatus 100 for managing the dual level reset of the microgrid gateway is constituted by a main processing unit (MPU) 110 and a watchdog manager 120. All the constituent elements of the apparatus 100 for managing the dual level reset of the microgrid gateway illustrated in FIG. 1 are not required constituent elements, and the apparatus 100 for managing the dual level reset of the microgrid gateway may be implemented by more constituent elements or less constituent elements than the constituent elements illustrated in FIG. 1.

The MPU 110 executes an overall control function of the apparatus 100 for managing the dual level reset of the microgrid gateway.

Further, the MPU 110 transfers (alternatively, transmits/outputs) a first trigger signal (alternatively, a first probe signal/a first general purpose input output (GPIO) signal/a signal set as a size of 1) to the watchdog manager 120 through a GPIO (alternatively, a GPIO port) (not illustrated), before executing any one function of a plurality of functions. Herein, the first trigger signal may be a pseudo code form.

Further, after any one function is executed, the MPU 110 transfers (alternatively, transmits/outputs) a second trigger signal (alternatively, a second probe signal/a second GPIO signal/a signal set as a size of 0) to the watchdog manager 120 through the GPIO.

As such, the MPU 110 may transfer an output pattern of the GPIO signal related with the corresponding specific function that may determine whether the corresponding function normally operates to the corresponding watchdog manager 120 by transferring each trigger signal to the watchdog manager 120 before and after executing the specific function.

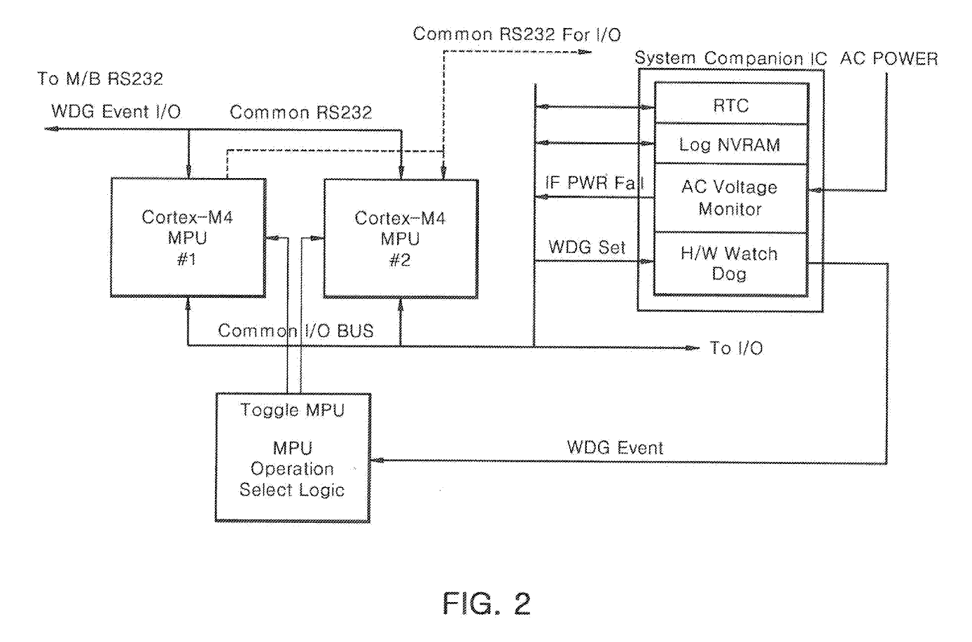

Further, as illustrated in FIG. 2, in order to reinforce efficiency of the monitoring function, the MPU 110 may be constituted in plural (alternatively, in dual).

The watchdog manager 120 receives the first trigger signal, the second trigger signal, and the like which are related with the specific function transferred from the MPU 110 through the GPIO.

Further, the watchdog manager 120 verifies a first reception time which is a time of receiving the first trigger signal, a second reception time which is a time of receiving the second trigger signal, and the like, respectively.

Further, the watchdog manager 120 collects (alternatively, verifies) the output pattern of the GPIO signal related with the corresponding function according to the first trigger signal and the second trigger signal based on the first reception time and the second reception time which are the times of receiving the first trigger signal and the second trigger signal.

Further, the watchdog manager 120 compares an output pattern of a predetermined normal pattern related with the corresponding function with the collected (alternatively, verified) output pattern of the GPIO signal.

That is, the watchdog manager 120 compares whether the output pattern of the GPIO signal is present in a predetermined error range of the output pattern of the normal pattern.

As the compared result, when the output pattern of the predetermined normal pattern related with the corresponding function coincides with the collected (alternatively, verified) output pattern of the GPIO signal (alternatively, when the output pattern of the GPIO signal is present in the predetermined error range of the output pattern of the normal pattern), the watchdog manager 120 verifies that the corresponding function is operating (alternatively, executing) in a normal state and performs the process of collecting and comparing the output pattern of the GPIO signal for another function of the plurality of functions.

Further, as the compared result, when the output pattern of the predetermined normal pattern related with the corresponding function does not coincide with the collected (alternatively, verified) output pattern of the GPIO signal (alternatively, when the output pattern of the GPIO signal is not present in the predetermined error range of the output pattern of the normal pattern/deviates from the error range), the watchdog manager 120 verifies that there is a problem in the corresponding function and resets (alternatively, initializes) the entire system (alternatively, the new generation energy management system) (not illustrated) including the apparatus 100 for managing the dual level reset of the microgrid gateway.

In this case, the watchdog manager 120 transmits a message to a control system (not illustrated) or the MPU 110, and the corresponding control system or the MPU 110 may also reset the entire system (not illustrated) including the apparatus 100 for managing the dual level reset of the microgrid gateway.

As such, the watchdog manager 120 may be constituted by a dual level watchdog for determining a normal operation state of the MPU, a power management unit (PMU), other processing units, and the like.

Further, as such, in a software error situation (for example, a situation in which the signal is more output than a predicted timer value (alternatively, an output pattern of the normal pattern) in time with regard to the output pattern of the GPIO signal by an exceptional situation), when an exceptional situation occurs in an interrupt service routine (ISR), a process may be a standby time for a flag of a first input first output (FIFO) buffer and the like.

Further, most of existing watchdogs are watchdogs in a hardware aspect, and when a hardware error occurs, the system is automatically forcibly reset to be made to a normal situation, but the response is difficult in the following exceptional situations.

1. That is, communication equipment (not illustrated), particularly, the gateway arranges various protocols input from various sensors to perform a function of relaying and transmitting the protocols to a higher server (not illustrated). For this reason, various processes are simultaneously used.

For example, a plurality of processes including a ZigBee process, a RS 485 process, a Bluetooth process, a Z-wave process, and the like are simultaneously used. When there is a problem in resource allocation of any one of the processes (alternatively, when only the allocation is continued without returning a memory), a flood of the memory allocation occurs, and thus, the system does not operate well regardless of whether another process is normal.

2. Further, when the system moves to an I/O flag standby state (for example, a standby state due to a FIFO full check problem between a communication device and a main process (alternatively, due to a fragmented load of the data) even though the communication is succeed in the communication of a terminal device), the process continuously lapses into the standby state and thus, the normal operation becomes a problem.

3. Further, due to a bad block generated when the number of times of a writing operation is limited by endurance of an NAND flash and checking quality is not complete, when a continuous writing-operation error occurs in a specific page of the NAND flash, a routine error is reported and there is a problem in the NAND flash which is in the standby state.

For example, in the case of KEPCO AMI meter data, the meter data (alternatively, determined as important data and not stored in an RAM) is stored in the NAND, a process interlocking for reading the meter data is present, and the NAND flash problem of reading standby when the writing is not completed may be generated.

4. Further, the control center (not illustrated) operates an operation having high complexity with a wrong intention or performs an operation having a lot of loads.

As such, when hardware processing is difficult and the system needs to be resolved by a software approach, the system may be automatically initialized by using two methods of hardware and software when the system is out of control.

That is, processing power and a logic error which may be generated in relation to an external device for the memory may be managed.

Further, the control system (alternatively, a remote/local server) transmits a ping signal to the MPU, the PMU, other processing units, and the like at a predetermined period and receives a response signal to the transmitted ping signal.

Further, when the response signal to the transmitted ping signal is not received predetermined times or more, the control system determines that there is a problem in the corresponding MPU, the PMU, other processing units, and the like and may reset the entire system including the apparatus 100 for managing the dual level reset of the microgrid gateway.

In the exemplary embodiment of the present invention, it is described that the watchdog manager 120 is constituted separately from the MPU 110, but the present invention is not limited thereto. The watchdog manager 120 may be constituted in the MPU 110 as a partial constituent element of the MPU 110.

That is, the function of the watchdog manager 120 may also be performed by the MPU 110.

As such, the reset function for the entire system may be performed when the software defect other than the hardware defect is verified.

Hereinafter, a method for managing a dual level reset of a microgrid gateway for a new generation energy management system according to the present invention will be described with reference to FIGS. 1 to 5.

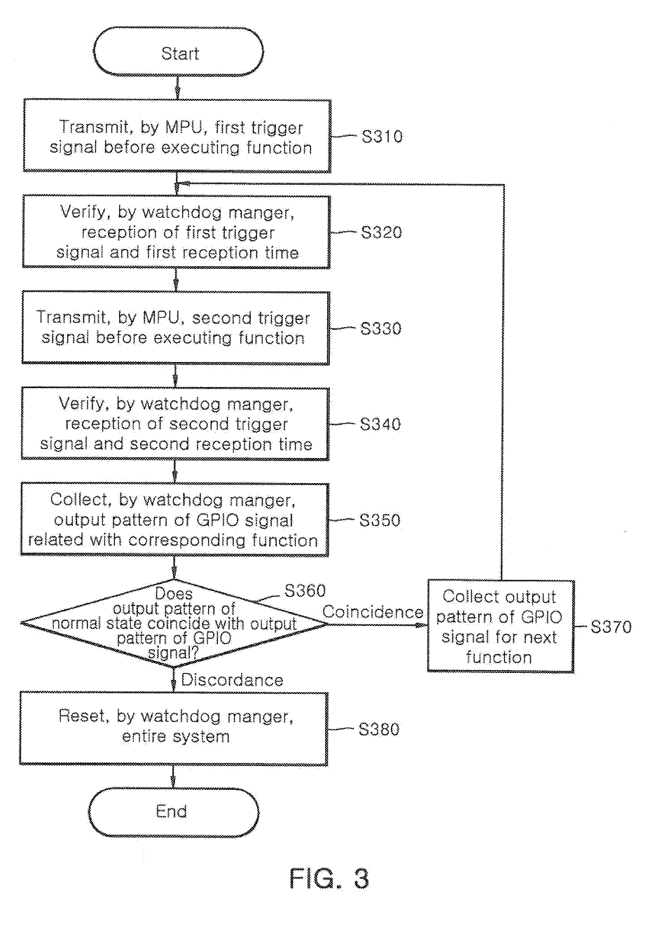

FIG. 3 is a flowchart illustrating a method for managing a dual level reset of a microgrid gateway for a new generation energy management system according to yet another exemplary embodiment of the present invention.

First, the MPU 110 transfers (alternatively, transmits/outputs) a first trigger signal (alternatively, a first probe signal/a first general purpose input output (GPIO) signal/a signal set as a size of 1) to the watchdog manager 120 through a GPIO (not illustrated), before executing any one function of a plurality of functions.

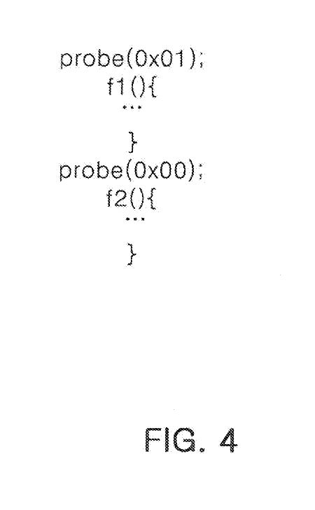

As an example, as illustrated in FIG. 4, the MPU 110 transfers the first probe signal (for example, the first probe signal set as the size of 1) for determining whether the corresponding f1 function normally operates before executing the f1 function to the watchdog manager 120 through the GPIO (S310).

Thereafter, the watchdog manager 120 receives a first trigger signal transmitted through the GPIO.

Further, the watchdog manager 120 verifies a first reception time which is a time of receiving the first trigger signal.

As an example, the watchdog manager 120 receives the first probe signal transmitted through the GPIO and verifies the first reception time receiving the corresponding first probe signal (S320).

Thereafter, after any one function is executed, the MPU 110 transfers (alternatively, transmits/outputs) a second trigger signal (alternatively, a second probe signal/a second GPIO signal/a signal set as a size of 0) to the watchdog manager 120 through the GPIO.

As an example, as illustrated in FIG. 4, the MPU 110 transfers the second probe signal (for example, the second probe signal set as the size of 0) for determining whether the corresponding f1 function normally operates after executing the f1 function to the watchdog manager 120 through the GPIO (S330).

Thereafter, the watchdog manager 220 receives the second trigger signal transmitted through the GPIO.

Further, the watchdog manager 120 verifies a second reception time which is a time of receiving the second trigger signal.

As an example, the watchdog manager 120 receives the second probe signal transmitted through the GPIO and verifies the second reception time when receiving the corresponding second probe signal (S340).

Thereafter, the watchdog manager 120 collects (alternatively, verifies) the output pattern of the GPIO signal related with the corresponding function according to the first trigger signal and the second trigger signal based on the first reception time and the second reception time which are the times of receiving the first trigger signal and the second trigger signal.

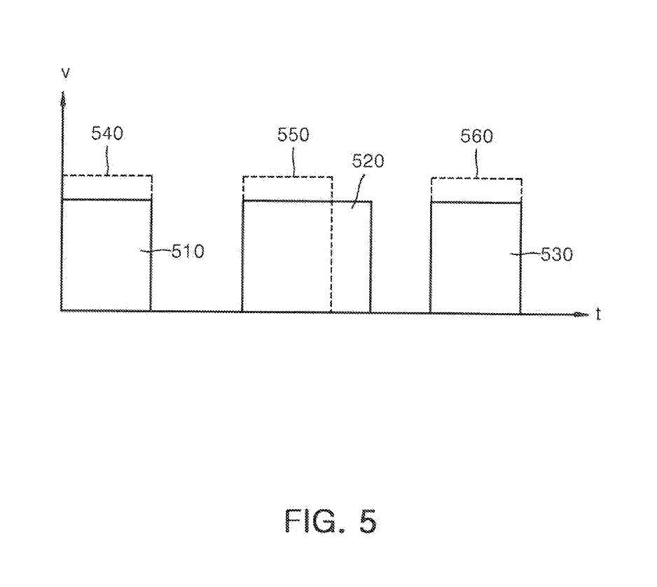

As an example, as illustrated in FIG. 5, the watchdog manager 120 collects an output pattern 510 of a first GPIO signal related with the f1 function, collects an output pattern 520 of a second GPIO signal related with the f2 function, and collects an output pattern 530 of a third GPIO signal related with the f3 function (S350).

Thereafter, the watchdog manager 120 compares an output pattern of a predetermined normal pattern related with the corresponding function with the collected (alternatively, verified) output pattern of the GPIO signal.

As an example, as illustrated in FIG. 5, the watchdog manager 120 compares an output pattern (a dotted line) 540 of the predetermined normal pattern related with the f1 function with an output pattern (a solid line) 510 of the first GPIO signal related with the collected f1 function.

As another example, as illustrated in FIG. 5, the watchdog manager 120 compares an output pattern (a dotted line) 550 of the predetermined normal pattern related with the f2 function with an output pattern (a solid line) 520 of the second GPIO signal related with the collected f2 function (S360).

As the compared result, when the output pattern of the predetermined normal pattern related with the corresponding function coincides with the collected (alternatively, verified) output pattern of the GPIO signal (alternatively, when the output pattern of the GPIO signal is present in the predetermined error range of the output pattern of the normal pattern), the watchdog manager 120 verifies that the corresponding function is operating (alternatively, executing) in a normal state and performs the process of collecting and comparing the output pattern of the GPIO signal for another function of the plurality of functions.

As an example, as illustrated in FIG. 5, when the output pattern (the dotted line) 540 of the predetermined normal pattern related with the f1 function coincides with the output pattern (the solid line) 510 of the first GPIO signal related with the collected f1 function (alternatively, a width of the output pattern 510 of the first GPIO signal coincides with a width of the output pattern 540 of the normal pattern), the watchdog manager 120 determines that the corresponding f1 function normally operates to perform the process of collecting and comparing the output pattern of the GPIO signal for the f2 function of the plurality of functions (S370).

Further, as the compared result, when the output pattern of the predetermined normal pattern related with the corresponding function does not coincide with the collected (alternatively, verified) output pattern of the GPIO signal (alternatively, when the output pattern of the GPIO signal is not present in the predetermined error range of the output pattern of the normal pattern/deviates from the error range), the watchdog manager 120 verifies that there is a problem in the corresponding function and resets the entire system (not illustrated) including the apparatus 100 for managing the dual level reset of the microgrid gateway.

As such, in a software error situation (for example, a situation in which the signal is more output than a predicted timer value (alternatively, an output pattern of the normal pattern) in time with regard to the output pattern of the GPIO signal by an exceptional situation), when an exceptional situation occurs in an ISR, a process may be a standby time for a flag of an FIFO buffer and the like.

As an example, as illustrated in FIG. 5, when the output pattern (the dotted line) 550 of the predetermined normal pattern related with the f2 function does not coincide with the output pattern (the solid line) 520 of the second GPIO signal related with the collected f2 function (alternatively, a width of the output pattern 550 of the normal pattern does not coincide with a width of the output pattern 520 of the second GPIO signal when a period/time of the output pattern of the second GPIO signal is larger than a period of the output pattern of the predetermined normal pattern), the watchdog manager 120 determines that the corresponding f2 function abnormally operates to control the entire system including the watchdog manager 120 to be reset (S380).

As described above, according to the exemplary embodiment of the present invention, it is possible to help a stable operation until a person for maintenance arrives on the scene to take action even though a fail occurs in the system by determining whether the system normally operates and enhance stability of a gateway, by performing a reset function for the entire system when a software defect other than a hardware defect is verified.

Hereinabove, although the present invention is described by specific matters such as concrete components, and the like, embodiments, and drawings, they are provided only for assisting in the entire understanding of the present invention. Therefore, the present invention is not limited to the embodiments. Various modifications and changes may be made by those skilled in the art to which the present invention pertains from this description. The scope of the present invention should be interpreted by the appended claims and all technical spirit in the equivalent range thereto should be interpreted to be embraced by the claims of the present invention.

According to the present invention, it is possible to help a stable operation until a person for maintenance arrives on the scene to take action even though a fail occurs in the system by determining whether the system normally operates and enhance stability of a gateway, by performing a reset function for the entire system when a software defect other than a hardware defect is verified. Thus, the present invention can be widely used in a failsafe design field, a new generation energy management field, a microgrid gateway field, and the like.

What is claimed is:

1. A method for managing a dual level reset of a microgrid gateway for a new generation energy management system, the method comprising:
transmitting, by a main processing unit (MPU), a first trigger signal through a general purpose input output (GPIO) before executing any one of a plurality of functions;
receiving, by a watchdog manager, the first trigger signal transmitted from the MPU;
transmitting, by the MPU, a second trigger signal to the watchdog manager through the GPIO after any one function is executed;
receiving, by the watchdog manager, the second trigger signal transmitted from the MPU;
collecting, by the watchdog manager, an output pattern of a GPIO signal related with the function according to the first trigger signal and the second trigger signal;
comparing, by the watchdog manager, an output pattern of a predetermined normal pattern related with the function with the collected output pattern, of the GPIO signal; and
resetting, by the watchdog manager, the entire system including the watchdog manager, when the output pattern of the predetermined normal pattern related with the function does not coincide with the collected output pattern of the GPIO signal as the compared result.

2. The method of claim 1, wherein in the comparing, whether the output pattern of the GPIO signal is present in a predetermined error range of the output pattern of the normal pattern is compared.

3. The method of claim 1, further comprising:
collecting the output pattern of the GPIO signal for another function of the plurality of functions, when the output pattern of the predetermined normal pattern related with the function coincides with the collected output pattern of the GPIO signal as the compared result.

4. An apparatus for managing a dual level reset of a microgrid gateway for a new generation energy management system, the apparatus comprising:
an MPU configured to transmit a first trigger signal through a GPIO before executing any one of a plurality of functions and transmit a second trigger signal through the GPIO after any one function is executed; and
a watchdog manager configured to collect an output pattern of a GPIO signal related with the function according to the first trigger signal and the second trigger signal which are transmitted from the MPU, respectively, compare an output pattern of a predetermined normal pattern related with the function with the collected output pattern of the GPIO signal, and reset the entire system including the watchdog manager, when the output pattern of the predetermined normal pattern related with the function does not coincide with the collected output pattern of the GPIO signal as the compared result.

5. The apparatus of claim 4, wherein the watchdog manager compares whether the output pattern of the GPIO signal is present in a predetermined error range of the output pattern of the normal pattern.

6. The apparatus of claim 4, wherein the watchdog manager collects the output pattern of the GPIO signal for another function of the plurality of functions, when the output pattern of the predetermined normal pattern related with the function coincides with the collected output pattern of the GPIO signal as the compared result.

7. The apparatus of claim 4, wherein the watchdog manager is constituted in the MPU.
